(19) United States
(12) Patent Application Publication
(10) Pub. No.: US 2004/0173702 A1
(43) Pub. Date: Sep. 9, 2004

(54) Refining element

(76) Inventor: Nils Virving, Hasselby (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/486,413

(22) PCT Filed: Jul. 31, 2002
(86) PCT No.: PCT/SE02/01421

(30) Foreign Application Priority Data
Aug. 15, 2001 (SE) 0102726-7

(51) Int. Cl. B02C 7/12

(52) U.S. Cl. 241/261.2

(57) ABSTRACT

A refiner system is disclosed including a first refiner element and a second refiner element adapted for mounting a refiner for relative rotation with a refining gap between them for processing lignocellulosic material, each of the first and second refiner elements including a refining surface, pins extending upwardly from the refining surfaces whereby the pins on the first refiner surface are disposed in intermediate spaces between the pins on the second refiner surface, each of the first and second refining surfaces further including bars including rounded edges forming a wave-shaped surface thereon.

This invention relates to refining elements for use in refiners of disc-type for processing, for example defibering, refining or disperging, lignocellulosic fibrous material in the form of chips or pulp. The object of the processing can be the manufacture of, for example, recycled fiber pulp or mechanical pulp, such as thermo-mechanical pulp (TMP) and chemi-thermo-mechanical pulp (CTMP). The invention, more precisely, relates to a pair of co-acting refining elements intended to be placed directly in front of each other on opposed refining discs in a refiner of the said type.

The processing of the fibrous material takes place in the refining gap, which is formed between the refining elements on two opposed refining discs rotating relative to one another. The material is thereby subjected to mechanical action by processing means on the refining elements, and at the same time the material moves outward by action of the centrifugal force. The processing means can be formed as continuous or discontinuous bars, teeth or in some other way.

At the defibering of fibrous material in the form of chips the chip bits are intended to be disintegrated to individual fibers with the least possible shortening of the fibers. Tests have shown, that the design of the refining elements in the inner portion of the refining gap is of great importance for the feed of the material through the refining gap as well as for the defibering process. At the disperging of recycled fiber pulp it is desired to obtain a processing which does not cause any shortening of the fibers or lowering of the freeness value (CSF) of the pulp.

The processing, which causes fibrillation and fiber shortening, takes place above all when the refining means are formed as bars by action of the edges of the bars.

Conventional refining elements with processing means in the form of bars with intermediate grooves can also give rise to a non-uniform material flow through the refining gap. This implies at the same time that the load on the motor or motors driving one or both of the refining discs will be uneven. As a result thereof, the process is difficult to control, and the energy consumption increases. It also can affect the quality of the processed pulp.

It is also known to form the refining elements with processing means in the form of projecting pins, where the pins from one refining element extend into the intermediate space between the pins on the opposed refining element. This type of refining elements is shown, for example, in SE patent specification No. 510 948. With these refining elements a lenient defibering process is obtained, which does not cause any fiber shortening. There is risk, however, of an insufficient defibering effect.

The present invention offers a solution of the aforesaid problems. Opposed co-acting refining elements shall be provided with projecting processing means in the form of pins, which extend upward from the bottom surface of the refining elements, where the pins on one refining element are arranged to extend into the intermediate space between the pins on the opposed co-acting refining element. The bottom surface of each of the refining elements between the pins shall be wave-shaped to co-operate with the tops of the pins on the opposed co-acting refining element.

The characterizing features of the invention are defined in the attached claims.

The invention is described in greater detail in the following, with reference to the accompanying drawing illustrating an embodiment of refining elements according to the invention.

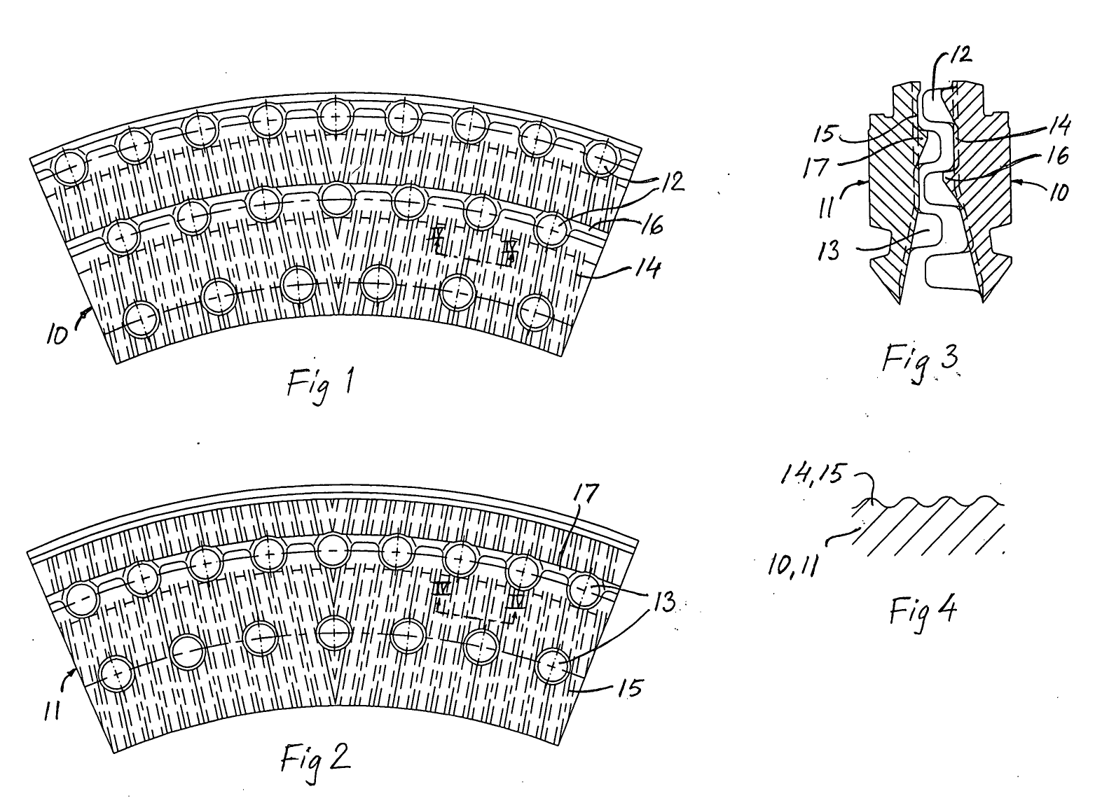

FIGS. 1 and 2 show a pair of co-acting refining elements according to the invention,

FIG. 3 is a cross-section of the refining elements seen from the side in processing position;

FIG. 4 shows an embodiment of the wave-shaped bottom surface of the refining elements by way of a cross-section according to IV-IV in FIGS. 1 and 2.

The co-acting refining elements 10,11 are intended to be placed on each of two opposed refining discs in a refiner, where the refining discs are rotary relative to one another. The refining elements shown are provided with projecting processing means in the form of pins 12,13 with substantially circular cross-section, which are placed in several rows in the circumferential direction. The rows of pins are arranged radially spaced from each other on the bottom surface of the refining elements.

The pins 12,13 should be arranged in at least two radially separated rows, and the pins should be substantially cylindric with a diameter of 10-30 mm, preferably 15-25 nun, and have rounded tops. The tops of the pins can be uniformly rounded or have a plane surface with rounded edges. The length should be 10-30 mm, preferably 15-25 mm. Alternatively, slightly conical pins can be used. The bottom surface of the refining elements between the pins is provided with bars 14,15 with rounded edges forming a wave-shaped surface. In processing position the pins shall extend transversely across the refining gap almost all the way to the surface of the opposed refining element, so that a narrow gap is formed between pins and bars.

The rounded bars suitably extend substantially radially across the entire portion of the refining elements which is provided with pins. Alternatively, the bars can be arranged at an angle in relation to the radius of the refining element. Thereby a feeding or braking effect can be obtained, depending on in which direction the bars are angled in relation to the direction of movement of the refining elements at the processing operation. The tops of the bars should be rounded in such a way, that a uniform wave-shaped pattern is formed on the bottom surface of the refining elements. This ensures a uniform and lenient processing. The height of the rounded bars should be 1-5 nun, suitably 2-4 mm, the roundness having a radius of 1-5 mm, suitably 2-4 mm.

The refining elements 10,11 can also be provided with flow restrictions in the form of ledges 16,17 extending substantially in the circumferential direction. The ledges shall be lower than the pins 12,13, but higher than the bars 14,15, suitably 4-12 mm, preferably 6-10 mm. The ledges can be placed in connection to the pins along circle arches. Alternatively, they can be given a direction, which slightly deviates from an arch, i.e. the radius increases or decreases along a ledge. The ledges can be continuous or discontinuous. Discontinuous ledges can extend between two pins.

At the outward passage of the material through the refining gap between the co-acting refining elements 10,11, the material will be processed partly at the passage between the tops of the pins 12,13 on one refining element and the rounded bars 14,15 on the opposed refilling element. By this combined processing an improved but simultaneously lenient defibering effect is obtained. The fibers of the material are separated and processed effectively without unfavourable fiber cutting, resulting in a high and uniform pulp quality.

The ledges 16,17 have the object to affect the stay-time of the material in the refining gap. The height and direction of the ledges, thus, are of decisive importance. This favourable effect on the material implies, that even a non-uniform supply of material is counter-balanced in the refining gap, which has a stabilizing effect on the entire processing process.

The invention, of course, is not restricted to the embodiments shown, but can be varied within the scope of the claims.

1. A pair of co-acting refining elements (10,11) intended for a refiner for processing lignocellulosic fibrous material in a refining gap between two opposed refining discs rotating relative to one another, where the refining elements (10,11) are intended to be placed directly in front of each other on opposed refining discs, where the refining elements (10,11) are provided with a plurality of processing means in the form of pins (12,13) extending upward from the bottom surface of the refining elements, and the pins on one refining element are arranged to extend into intermediate spaces between the pins on the other refining element, characterized in that the bottom surface of each refining element (10,11) between the pins (12,13) is provided with bars (14,15) with rounded edges, which form a wave-shaped surface for co-operation with the tops of the pins (12,13) on the opposed refining element.

2. Refining elements as defined in claim 1, characterized in that the tops of the pins (12,13) are rounded.

3. Refining elements as defined in any one of the preceding claims, characterized in that the bars (14,15) extend substantially radially across each refining element.

4. Refining elements as defined in any one of the preceding claims, characterized in that flow restrictions in the form of ledges (16,17) are placed along circle arches on the bottom surface of the refining elements in connection to the pins (12,13).
